(19) United States
(12) Patent Application Publication
(10) Pub. No.: US 2026/0104359 A1
(43) Pub. Date: Apr. 16, 2026

(54) MONITORING TIME-VARYING FLUORESCENCE EMITTED FROM AN EXOGENOUS FLUORESCENCE AGENT

(71) Applicant: MediBeacon Inc., St. Louis, MO (US)

(72) Inventors: Martin Debreczeny, St. Louis, MO (US); Kate Bechtel, St. Louis, MO (US); Augustus Lowell, St. Louis, MO (US)

(21) Appl. No.: 19/340,233

(22) Filed: Sep. 25, 2025

Related U.S. Application Data
(60) Provisional application No. 63/699,490, filed on Sep. 26, 2024.

(51) Int. Cl. G01N 21/64

(52) U.S. Cl. CPC G01N 21/6408; G01N 21/6428; G01N 2021/6415; G01N 2021/6439; G01N 2201/1247; G01N 2201/12784

(57) ABSTRACT

Method is presented for monitoring time-varying fluorescence. The method includes providing a measurement data set, transforming each Flr signal of each measurement data entry of the measurement data set to an agent intrinsic fluorescent (IF) signal, monitoring the agent IF signal for each measurement data entry within the measurement data set, whereby fluorescence emission of the agent is determined with reduced sensitivity to the time-varying optical properties of the medium.

### CROSS-REFERENCE TO RELATED APPLICATION

This application is related to and claims priority under 35 U.S.C. § 119 from U.S. Provisional Application No. 63/699,490 filed Sep. 26, 2024, the entire contents of which are fully incorporated by reference herein for all purposes.

### FIELD

The present disclosure relates generally to generating an intrinsic fluorescence signal from an exogenous fluorescent agent and methods of the same.

### BACKGROUND

Monitoring of renal function in patients that are critically ill or injured is important. Renal function can be impaired due to kidney damage, acute lung injury, adult respiratory distress syndrome, and others. Assessing renal function over time allows for determination of renal failure.

### BRIEF DESCRIPTION OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not, therefore, to be considered to be limiting of its scope, the principles herein are described and explained with additional specificity and detail through the use of the accompanying drawings in which:

FIG. 1 is a schematic illustration of a single light source monitoring device in one aspect;

FIG. 2 illustrates illumination from a light source and exogenous fluorescence agent, and detection by a first detector and a second detector;

FIG. 3 illustrates illumination of light from another light source and detection by a first detector and a second detector;

FIG. 4 is a schematic illustration of a multi-light source monitoring system in one aspect;

FIG. 5 illustrates an example of a sensor head having one or more light sources and two detectors;

FIG. 6 is an exploded view of the inner housing of the sensor head illustrated in FIG. 5;

FIG. 7 is a graph summarizing the absorption, transmission, and emission spectra of various devices, materials, and compounds associated with the non-invasive monitoring of an exogenous fluorescent agent in vivo defined over light wavelengths ranging from about 430 nm to about 650 nm;

FIG. 8 illustrates a flow chart corresponding to a method of monitoring time-varying fluorescence emitted from an exogenous fluorescent agent from within a diffuse reflecting medium with time-varying optical properties;

FIG. 9 illustrates a flow chart corresponding to another method of monitoring time-varying fluorescence emitted from an exogenous fluorescent agent from within a diffuse reflecting medium with time-varying optical properties;

FIG. 10 illustrates a flow chart corresponding to yet another method of monitoring time-varying fluorescence emitted from an exogenous fluorescent agent from within a diffuse reflecting medium with time-varying optical properties;

FIG. 11 illustrates a flow chart corresponding to a method of correcting baseline data in monitoring time-varying fluorescence emitted from an exogenous fluorescent agent;

FIG. 12 illustrates a flow chart corresponding to yet another method of correcting baseline data in monitoring time-varying fluorescence emitted from an exogenous fluorescent agent;

FIGS. 13A-13D illustrate example depictions of optical pathlengths traveled through tissue;

FIG. 14 illustrates a flow chart corresponding to a method for calculating a baseline;

FIG. 15A illustrates examples of intrinsic fluorescent, fluorescence emission, diffuse reflectance emission, and diffuse reflectance excitation signals in a normalized intensity plot as a function of time; and

FIG. 15B illustrates examples of intrinsic fluorescent, fluorescence emission, diffuse reflectance emission, and diffuse reflectance excitation signals in a normalized intensity plot as a function of time.

### DETAILED DESCRIPTION

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

As used herein, the terms “comprises,” “comprising,” “includes,” “including,” “has,” “having” or any other variation thereof, are intended to cover a non-exclusive inclusion. For example, a process, product, article, or apparatus that comprises a list of elements is not necessarily limited only those elements but can include other elements not expressly listed or inherent to such process, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term substantially, as used herein, is defined to be essentially conforming to the particular dimension, shape or other word that substantially modifies, such that the component need not be exact. For example, substantially cylindrical means that the object resembles a cylinder, but can have one or more deviations from a true cylinder.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

The phrase “diffuse reflecting medium” refers to any material through which light propagates, which includes a plurality of moieties, particles, or molecules that can scatter, reflect, and/or absorb the light as it propagates. The distribution of the plurality of moieties, particles, and/or molecules can be uniform or non-uniform and can change over time.

The present disclosure solves the problem of increasing accuracy of calculating the renal function in a patient based upon an intrinsic fluorescence (IF) signal. The present disclosure makes use of a unique filtering of the IF signal to determine an equilibration point based on an initial equilibration portion that is calculated. In at least one example, the initial equilibration portion can be calculated using a known technique. In other examples, the initial equilibration portion can be calculated with a novel technique. The IF signal is based upon use of a suitable exogenous fluorescent agents that is injected into a patient.

Suitable exogenous fluorescent agents for use with the methods and devices described herein are disclosed in U.S. Pat. Nos. 8,155,000, 8,664,392, 8,697,033, 8,703,100, 8,722,685, 8,778,309, 9,005,581, 9,283,288, 9,376,399, RE47,413, RE47,255, 10,137,207, 10,525,149, and 11,590,244, which are all incorporated by reference in their entirety for all purposes. In some aspects, the exogenous fluorescent agent is eliminated from the body of a patient by glomerular filtration. In some aspects, the exogenous fluorescent agent is eliminated from the body of a patient only by glomerular filtration. In some aspects, the exogenous fluorescent agent is a GFR agent. In some aspects, the exogenous fluorescent agent is relmapirazin (also referred to as MB-102).

Disclosed are systems, apparatuses, methods, computer readable medium, and circuits for monitoring a biological parameter indicative of organ function using an exogenous fluorescent agent in a patient.

In at least one example, a method is presented for monitoring time-varying fluorescence emitted from an exogenous fluorescent agent from within a diffuse reflecting medium with time-varying optical properties. The method can include providing a measurement data set comprising a plurality of measurement entries comprising at least two measurements obtained at each data acquisition time from a patient that is administered the exogenous fluorescent agent, the at least two measurements having: at least one diffuse reflectance (DR) signal and at least one fluorescence emission (Flr) signal. The method can also include transforming each Flr signal of each measurement data entry of the measurement data set to an agent intrinsic fluorescent (IF) signal representing a detected fluorescence intensity emitted by the exogenous fluorescent agent from within the diffuse reflecting medium, wherein transforming the Flr signal comprises periodically combining the at least two measurements according to a transformation relation comprising at least one variable pathlength factor for the at least one DR signal, wherein the at least one variable pathlength factor is re-determined periodically. Furthermore, the method can include monitoring the agent IF signal for each measurement data entry within the measurement data set, whereby fluorescence emission of the agent is determined with reduced sensitivity to the time-varying optical properties of the medium.

In at least another example, the present disclosure includes a method of monitoring time-varying fluorescence emitted from an exogenous fluorescent agent from within a diffuse reflecting medium with time-varying optical properties. The method can include obtaining a measurement data set comprising a plurality of measurement entries comprising at least two measurements obtained at one data acquisition time from a patient before and after administration of the exogenous fluorescent agent, the at least two measurements comprising: a diffuse reflectance (DR) signal and a fluorescence emission (Flr) signal. Additionally, the method can include generating at least one coefficient value for combining the DR and Flr signals from at least a portion of the measurement data set obtained prior to administration of the exogenous fluorescent agent to calculate a baseline intrinsic fluorescence (IF) signal. Furthermore, the method can include searching for the baseline IF signal having a minimum variance and constrained to a maximum drift over a predetermined time window. Still further, the method can include storing the at least one coefficient value of the baseline IF having the minimum variance and constrained to a maximum drift over the predetermined time window. Additionally, the method can include creating a baseline-corrected agent IF signal by combining the stored at least one coefficient value with the Flr and DR signals collected after administration of the fluorescence agent. Furthermore, the method can include monitoring the agent IF signal for each measurement data entry within a post-agent-administration portion of the measurement data set, whereby the fluorescence emission of the agent is determined with reduced sensitivity to the time-varying optical properties of the medium.

In yet another example, the present disclosure includes a method of monitoring time-varying fluorescence emitted from an exogenous fluorescent agent from within a diffuse reflecting medium with time-varying optical properties. The method can include providing a measurement data set comprising a plurality of measurement entries comprising at least four measurements obtained at one data acquisition time from a patient before and after administration of the exogenous fluorescent agent, the at least four measurements including: a diffuse reflectance signal at an emission wavelength of the fluorescent agent measured on a first detector that is not optically filtered (DR_{em,unfiltered}); a diffuse reflectance signal at an emission wavelength of the fluorescent agent measured on a second detector that is optically filtered (DR_{em,filtered}); a diffuse reflectance signal at an excitation wavelength of the fluorescent agent measured on the first detector (DRₑₓ); and a fluorescence emission signal (Flr) measured on the second detector. The method can also include identifying a post-agent-administration portion of the measurement data set. Additionally, the method can include transforming each DRₑₓ signal of each measurement data entry of the measurement data set to a DR_{ex,corr} signal by combining the DRₑₓ signal with the DR_{em,filtered}, DR_{em,unfiltered}, Flr signals and a heterogeneity factor to reduce a Flr contribution to the DRₑₓ signal. Furthermore, the method can include determining the heterogeneity factor by comparing the DR_{ex,corr} signal before and after the agent administration. Still further, the method can include transforming each Flr signal of each measurement data entry of the measurement data set to an intrinsic fluorescent (IF) signal representing a detected fluorescence intensity emitted by the exogenous fluorescent agent from within the diffuse reflecting medium, wherein transforming the Flr signal comprises combining the Flr, DR_{em,filtered} and DR_{ex,corr} signals. Furthermore, the method can include monitoring the IF signal for each measurement data entry within the measurement data set, whereby the fluorescence emission of the agent is determined with reduced sensitivity to the time-varying optical properties of the medium.

The present disclosure can further include a method of correcting baseline data in monitoring time-varying fluorescence emitted from an exogenous fluorescent agent. The method can include obtaining a measurement data set comprising a plurality of measurement entries comprising at least two measurements obtained at one data acquisition time from a patient before and after administration of the exogenous fluorescent agent, the at least two measurements comprising: a diffuse reflectance (DR) signal and a fluorescence emission (Flr) signal. Additionally, the method can include generating at least one coefficient value for predicting a Flr baseline signal from the DR signal, wherein the at least one coefficient value is established using a correlation between the DR signal and Flr signal. Furthermore, the method can include storing the at least one coefficient value. Still further, the method can include calculating a predicted post-agent administered Flr signal using the at least one coefficient value. Additionally, the method can include calculating an intrinsic fluorescence (IF) signal and creating a baseline-corrected agent IF signal by subtracting an auto-fluorescence contribution based on the predicted post-agent administer Flr signal from the calculated IF signal.

The present disclosure provides enhanced methods in monitoring time-varying fluorescence emitted from an exogenous fluorescence agent.

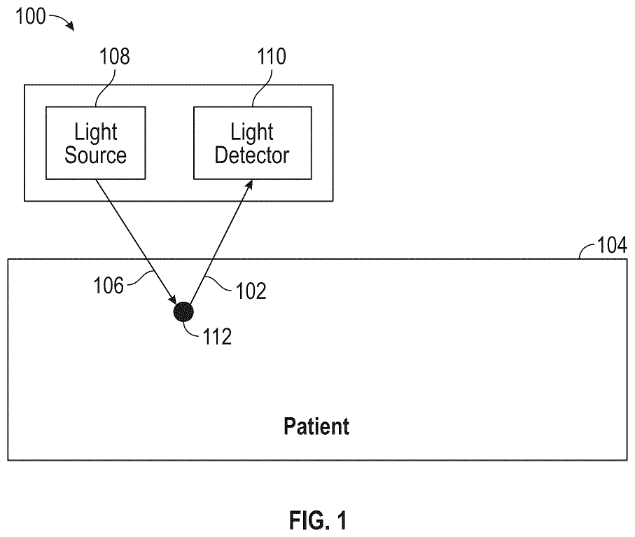

FIG. 1 is a schematic illustration of a system 100 in which an exogenous fluorescent agent 112 is administered to a patient. A light source 108 emits light 106 into the patient 104. The light 106 can be described as an excitation light or an excitation light source. The light 106 can also be controlled to be at one wavelength, multiple wavelengths that vary over time, or multiple wavelengths emitted simultaneously. The exogenous fluorescent agent 112 produces fluorescence 102 in response to an excitation event including: illumination by light 106 at an excitation wavelength (λₑₓ), occurrence of an enzymatic reaction, changes in local electrical potential, and any other known excitation event associated with exogenous fluorescent agents. The light source 108 can be configured to deliver light 106 at an excitation wavelength (λₑₓ) to the patient 104. Fluorescence 102 can be produced as described above. In at least one example, the excitation wavelength (λₑₓ) of the light 106 and the emission wavelength (λₑₘ) of the fluorescence 102 can be spectrally distinct (i.e., (λₑₓ) is sufficiently different from (λₑₘ) so that the light detector 110 can be configured to selectively detect only the fluorescence 102 by the inclusion of any known optical wavelength separation device including an optical filter).

Change in the fluorescence 102 can be analyzed to obtain information regarding organ function of the patient 104. As described herein, two non-limiting examples of organ function can be one of renal function and/or intestinal wall barrier function. In one example, the rate of decrease in fluorescence 102 can be proportional to the rate of removal of the exogenous fluorescent agent 112 by one or more organs of the patient 104, thereby providing a biological parameter value. In another non-limiting example, the rate of decrease in fluorescence 102 can be proportional to the rate of removal of the exogenous fluorescent agent 112 by the kidneys of the patient 104, thereby providing a measurement of renal function including: renal clearance rate constant (or renal decay time constant (RDTC) or the inverse, renal clearance time constant) and/or glomerular filtration rate (GFR). Additionally, the present disclosure can calculate a permeability or leak measurement when the functioning of the intestines is measured.

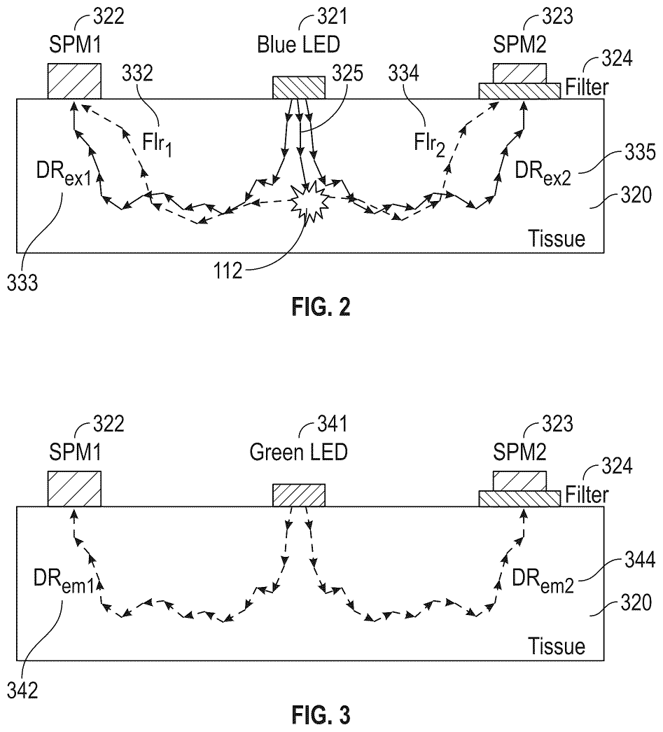

FIG. 2 illustrates using a light source 108 in the form of an excitation light emitting diode (LED) 321 in the presence of the exogenous fluorescent agent 112. The excitation LED 321 can emit light at one or more different excitation wavelengths. In one example, the excitation light wavelength can be a blue light. In other examples, the excitation light wavelength can be a blue light and a green light. In other examples, the excitation light wavelength can be chosen based upon the selected exogenous fluorescent agent 112. The light detector 110 can be in the form of a first light detector 322 and a second light detector 323. As illustrated the first light detector 322 can receive a first signal labeled SPM1 and the second light detector 323 can receive a second signal labeled SPM2. In at least one example, the first light detector 322 and the second light detector 323 can be a silicon photomultiplier. While the light detectors 322, 323 can take a varied of different forms, the silicon photomultiplier and/or photo diodes can provide for desired characteristics to perform the measurements to achieve the desired accuracy for these measurements.

Additionally, a filter 324 can be configured to filter out light prior to the second detector 323 receiving the light. The filter 324 can be configured to substantially or fully block excitation light wavelength. Additionally, the filter 324 can be configured to allow light that is emitted from the exogenous fluorescent agent to pass therethrough substantially unimpeded. In the illustrated example, the excitation light wavelength can be a blue wavelength and the filter 324 can be configured to allow green light to pass therethrough. As a result, the first detector 322 is configured to measure light received at both the excitation and emission wavelengths, and the second detector 323 is configured to detect light received at the emission wavelength only. Combined with the illumination of the tissues 320 of the patient 104 with light at the excitatory wavelength only and at the emission wavelength only in an alternating series, the measurements from the first detector 322 and a second detector 323 may be analyzed as described in U.S. Pat. Nos. 10,548,521, 10,980,459, 10,952,656, 11,478,172 and 10,194,854 to measure the fluorescence of an exogenous fluorescence agent and to correct the fluorescence measurements by removing the effects of autofluorescence, excitation-wavelength light leak-through and the diffuse reflectance of light according to the correction methods described therein. While the illustrated example only includes a single filter 324, in examples an additional filter can be configured to filter out light prior to the first light detector 322. In other examples, a single filter can be placed before the first light detector 322 rather than the second light detector 323.

The excitation LED 321 (for example, a blue LED) can emit light 325 that is directed toward the exogenous fluorescent agent 112. Additionally, light emitted from the excitation LED 321 can travel through the patient 104 such that the tissue 320 of the patient serves to diffuse the light. The diffuse light at the same wavelength as the excitation source can be referred to as a diffuse reflectance (DR) signal. Additionally, the light 325 that impacts the exogenous fluorescent agent 112 and the fluorescence emission (Flr) signal 334 travel to the detectors 322, 323. As illustrated, the first detector 322 receives a DR signal 333 labeled as DRex₁ (also referred to herein, in at least one aspect, as DRₑₓ), and a Flr signal 332 labeled as Flr₁, and the second detector 323 receives a DR signal 335 labeled as DRex₂ (excitation-wavelength light leak-through) and a Flr signal 334 labeled as Flr₂. The Flr signals 332 and 334 include contributions from the exogenous fluorescent agent 112 and tissue autofluorescence. These measurements are used to arrive at intrinsic fluorescence (IF) signal that is representative of the fluorescence from just the agent as described herein.

FIG. 3 illustrates using a light source 108 in the form of another light emitting diode (LED) 341. In one example, the another LED 341 can be a green LED. In yet other examples, the another LED 341 can be other types of LEDs that provide light at a different wavelength from the excitation LED 321. In one example, the another LED 341 can be operable to emit light in substantially the same wavelength as the emission from the exogenous agent. In other examples, a single LED capable of emitting light at various wavelengths can be implemented. Light emitted from the another LED 341 can travel through the patient 104 such that the tissue 320 of the patient serves to diffuse the light. The diffuse light can be referred to a DR signal, as described herein. As illustrated, the first detector 322 receives a DR signal 342 labeled as DRem₁ (also referred to herein in at least one aspect as DR_{em, unfiltered}), and the second detector 323 receives a DR signal 344 labeled as DRem₂ (also referred to herein in at least one aspect as DR_{em, filtered}). As in FIG. 2, a filter 324 can be implemented. This filter can be the same as in FIG. 2. While the another LED 341 and excitation LED 321 are indicated as being separate from one another, the another LED 341 and excitation LED 321 can be coupled to one another. While the illustrated example only includes a single filter 324, in examples an additional filter can be configured to filter out light prior to the first detector 322. In other examples, a single filter can be placed before the first detector 322 rather than the second detector 323.

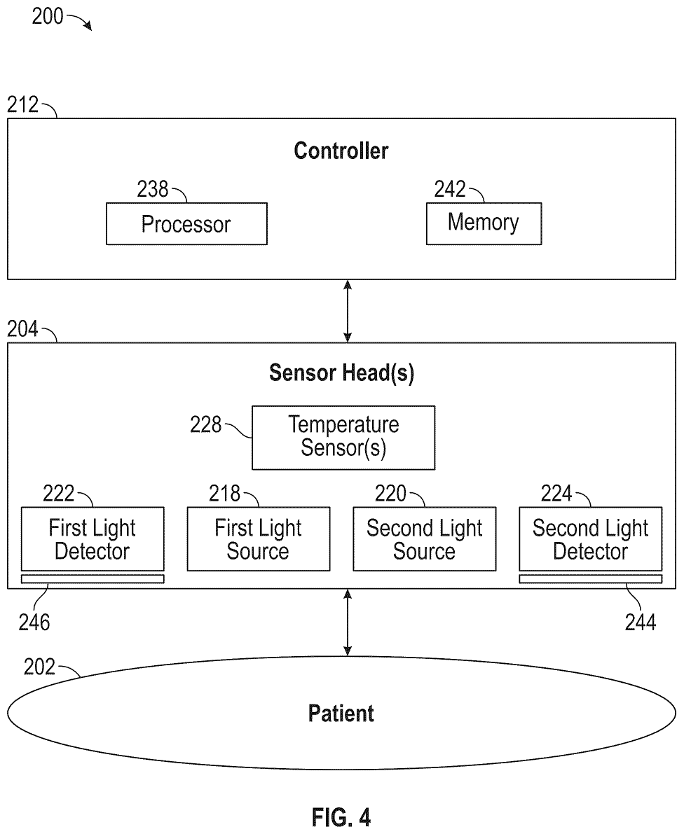

FIG. 4 is an example schematic illustration of an organ monitoring system 200. The system can include a controller 212 that includes a processor 238 and a memory 242. The controller 212 can be coupled to one or more sensor head(s) 204. Each sensor head can include a first light source 218 and a second light source 220. The first light source 218 can be an excitation LED as indicated above. The second light source 220 can be another LED as indicated above. In other examples, the excitation LED can be the second light source 220 and the another LED can be the first light source 218. As illustrated a first light filter 246 and a second light filter 244 is included. In other examples, only one of the first light filter 246 and second light filter 244 can be implemented, such as described in regards to FIGS. 2 and 3. The sensor head 204 can optionally include one or more temperature sensor(s) 228. The one or more temperature sensor(s) 228 can collect data at the same time as the data being collected from the first light detector 222 and/or second light detector 224. The one or more temperature sensor(s) 228 can be used to determine characteristics associated with the first light detector 22 and/or second light detector 224. Additionally, the one or more temperature sensor(s) 228 can be arranged to provide information regarding the patient 202. While the illustrated example includes the controller 212 as separate from the sensor head(s) 204, in other examples the controller 212 and sensor head 204 can be part of a single unit rather than being coupled either wired or wirelessly.

The first light source 218 and second light source 220 can be configured to emit light into the patient 202. The light can be diffused within the patient and a portion of the light is received at the first light detector 222 and/or a portion of the light is received at the second light detector 224. The data obtained by the first light detector 222 and/or the second light detector 224 can be transmitted to the controller 212. The data can be stored in memory 242 or another storage device with which the controller is in electronic communication.

The processor 238 can be operable to execute instructions according to one or more methods as described herein. The processor 238 can be operable to calculate a biological parameter value. In one example, the biological parameter value can be one or more of a GFR and/or RDTC. In other examples, the biological parameter value can be a parameter to describe permeability and/or leaks of the intestinal wall.

In various aspects, the first light source 218 and the second light source 220 can be any light source configured to deliver light at the excitatory wavelength and at the emission wavelength. Typically, the first light source 218 delivers light at an intensity that is sufficient to penetrate the tissues of the patient 202 to the exogenous fluorescent agent with sufficient intensity remaining to induce light at the emission wavelength by the exogenous fluorescent agent. Typically, the first light source 218 delivers light at an intensity that is sufficient to penetrate the tissues of the patient 202 to the exogenous fluorescent agent with sufficient intensity remaining after scattering and/or absorption to induce fluorescence at the emission wavelength by the exogenous fluorescent agent. However, the intensity of light delivered by the first light source 218 is limited to an upper value to prevent adverse effects such as tissue burning, tissue tanning, cell damage, and/or photo-bleaching of the exogenous fluorescent agent and/or the endogenous chromophores in the skin (“auto-fluorescence”).

Similarly, the second light source 220 delivers light at the emission wavelength of the exogenous fluorescent agent at an intensity configured to provide sufficient energy to propagate with scattering and absorption through the first region of the patient and out the second region and third region with sufficient remaining intensity for detection by the first light detector 222 and the second light detector 224, respectively. As with the first light source 218, the intensity of light produced by the second light source 220 is limited to an upper value to prevent the adverse effects such as tissue burning, tissue tanning, cell damage, and/or photo-bleaching of the exogenous fluorescent agent and/or the endogenous chromophores in the skin (“auto-fluorescence”).

In various aspects, the first light source 218 and the second light source 220 can be any light source suitable for use with fluorescent medical imaging systems and devices. Non-limiting examples of suitable light sources include: LEDs, diode lasers, pulsed lasers, continuous waver lasers, xenon arc lamps or mercury-vapor lamps with an excitation filter, lasers, and supercontinuum sources. In one aspect, the first light source 218 and/or the second light source 220 can produce light at a narrow spectral bandwidth suitable for monitoring the concentration of the exogenous fluorescence agent using the method described herein. In another aspect, the first light source 218 and the second light source 220 can produce light at a relatively wide spectral bandwidth.

In one aspect, the selection of intensity of the light produced by the first light source 218 and the second light source 220 by the system 200 can be influenced by any one or more of at least several factors including, but not limited to, the maximum permissible exposure (MPE) for skin exposure to a laser beam according to applicable regulatory standards such as ANSI standard Z136.1. In another aspect, light intensity for the system 200 can be selected to reduce the likelihood of photobleaching of the exogenous fluorescent source and/or other chromophores within the tissues of the patient 202 including, but not limited to: collagen, keratin, elastin, hemoglobin, nicotinamides and riboflavins within red blood cells and/or melanin within melanocytes. In yet another aspect, the light intensity for the system 200 can be selected in order to elicit a detectable fluorescence signal from the exogenous fluorescent source within the tissues of the patient 202 and the first light detector 222 and/or second light detector. In yet another aspect, the light intensity for the system 200 can be selected to provide suitably high light energy while reducing power consumption, inhibiting heating/overheating of the first light source 218 and the second light source 220, and/or reducing the exposure time of the patient's skin to light from the first light detector 222 and/or second light detector.

In various aspects, the intensity of the first light source 218 and the second light source 220 can be modulated to compensate any one or more of at least several factors including, but not limited to: individual differences in the concentration of chromophores within the patient 202, such as variation in skin pigmentation. In various other aspects, the detection gain of the light detectors can be modulated to similarly compensate for variation in individual differences in skin properties. In an aspect, the variation in skin pigmentation can be between two different individual patients 202, or between two different positions on the same patient 202. In an aspect, the light modulation can compensate for variation in the optical pathway taken by the light through the tissues of the patient 202. The optical pathway can vary due to any one or more of at least several factors including but not limited to: variation in separation distances between the light sources and light detectors of the system 200; variation in the secure attachment of the sensor head 204 to the skin of the patient 202; variation in the light output of the light sources due to the exposure of the light sources to environmental factors such as heat and moisture; variation in the sensitivity of the light detectors due to the exposure of the light detectors to environmental factors such as heat and moisture; modulation of the duration of illumination by the light sources, and any other relevant operational parameter.

In various aspects, the first light source 218 and the second light source 220 can be configured to modulate the intensity of the light produced as needed according to any one or more of the factors described herein above. In one aspect, if the first light source 218 and the second light source 220 are devices configured to continuously vary output fluence as needed, for example LED light sources, the intensity of the light can be modulated electronically using methods including, but not limited to, modulation of the electrical potential, current, and/or power supplied to the first light source 218 and/or the second light source 220. In another aspect, the intensity of the light can be modulated using optical methods including, but not limited to: partially or fully occluding the light leaving the first light source 218 and the second light source 220 using an optical device including, but not limited to: an iris, a shutter, and/or one or more filters; diverting the path of the light leaving the first light source 218 and the second light source 220 away from the first region of the patient using an optical device including, but not limited to a lenses, a mirror, and/or a prism.

In various aspects, the pulse width of the light produced by the first light source 218 and the second light source 220 can be independently selected to be a duration ranging from about 0.0001 seconds to about 0.5 seconds.

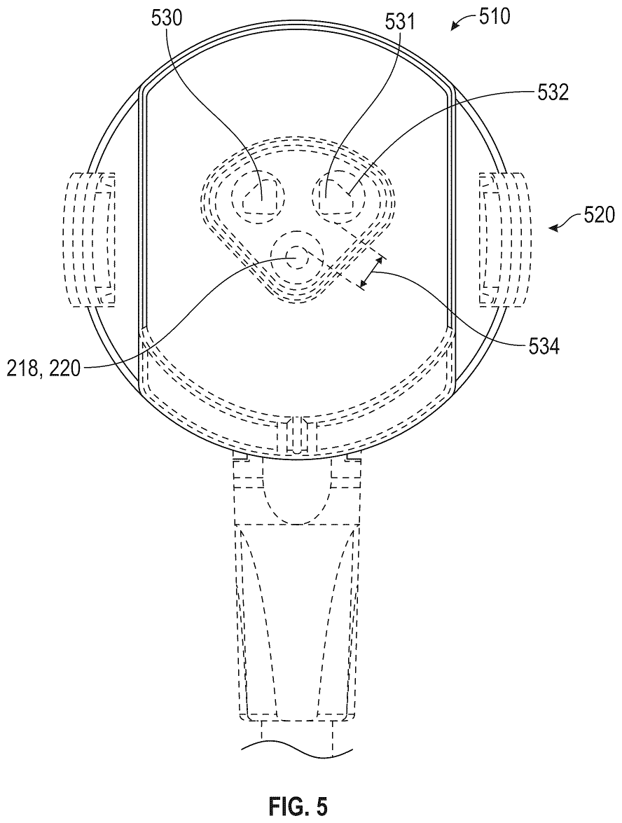

FIG. 5 illustrates an example of a sensor head having one or more light sources and two or more light detectors. As illustrated, a single aperture 531 formed in the sensor head 510 allows light from a first light source 218 and a second light source 220 to pass therethrough. The sensor head 510 also includes a first detector 530 and a second detector 532. Respective apertures 531 can be formed in the sensor head 510 to allow light to reach the first detector 530 and/or the second detector 532. A distance 534 separates the second detector 532 from the one or more light sources 218, 220. The sensor head 510 can also include clip receivers 520 that are designed to be coupled to one or more components not shown.

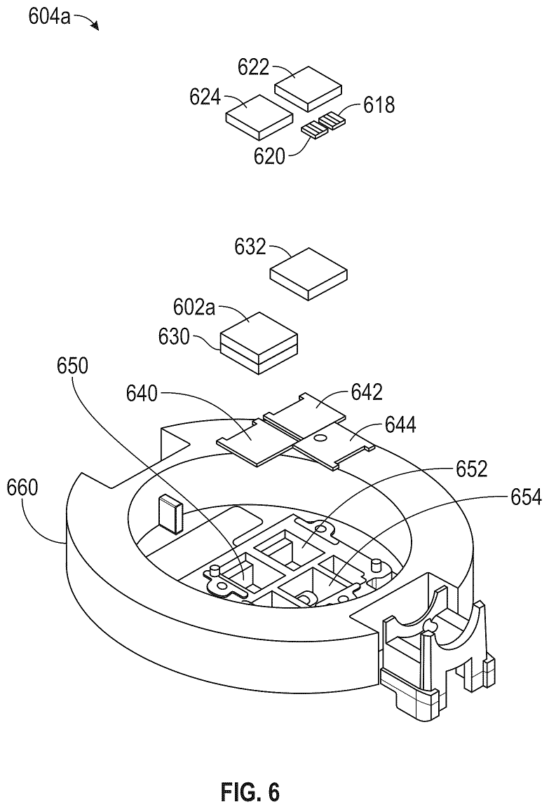

FIG. 6 is an exploded view of an inner housing 660 of the sensor head 510 illustrated in FIG. 5. FIG. 6 is an isometric view of the sensor head 604a with the upper housing and various electrical components removed to expose an inner housing 660. The inner housing 660 is contained within the housing. The inner housing 660 contains a sensor mount with a first detection well 652, a second detection well 650, and a light source well 654 formed therethrough. The first light detector 622 is mounted within the first detection well 652 and the second light detector 624 is mounted within the second detection well 650. The first and second light sources 618/620 are mounted within the light source well 654. In an aspect, the first detection well 652, second detection well 650, and light source well 654 of the sensor mount are optically isolated from one another to ensure that light from the light sources 618/620 does not reach the light detectors 622/624 without coupling through the skin of the patient. The separation between the two detection wells 652/650 ensures that the detected fluorescence signal from the exogenous fluorescent agent is distinguishable from the unfiltered excitation light, as described in detail above.

In one aspect, optically transparent windows 640, 642, and 644 are coupled within first detection aperture, second detection aperture, and light source aperture, respectively, to seal the apertures while also providing optically transparent conduits between the tissues and the interior of the sensor head 604a. In addition, diffusers 630, 632 are coupled over optically transparent windows 640, 642, and 644, respectively. The diffusers 630, 632 are provided to spatially homogenize light delivered to the tissues by light sources 618/620 and to spatially homogenize light detected by light detectors 622/624. In an aspect, the absorption filter 602a is coupled to the diffuser 630. In one aspect, an optically transparent adhesive is used to couple the absorption filter 602a to the diffuser 630.

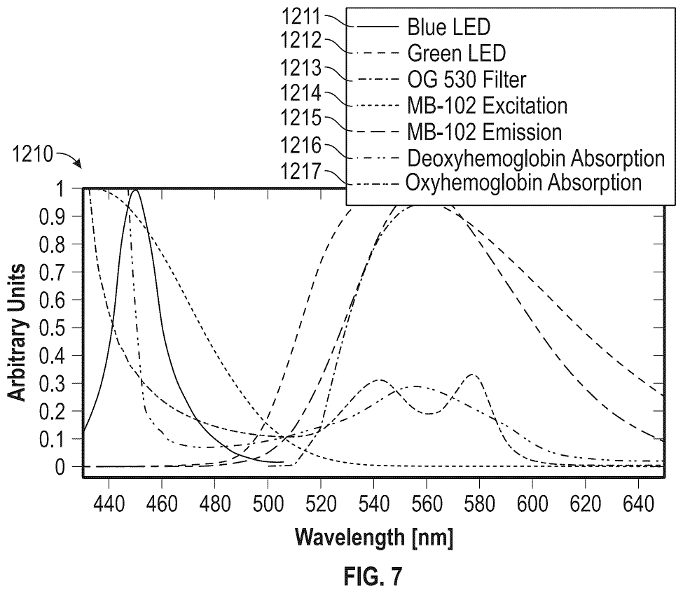

FIG. 7 is a graph 1210 summarizing the absorption, transmission, and emission spectra of various devices, materials, and compounds associated with the non-invasive monitoring of an exogenous fluorescent agent in vivo defined over light wavelengths ranging from about 430 nm to about 650 nm. By way of illustrative example, FIG. 7 is a graph summarizing the absorption spectra for (HbO₂) and (Hb), as well as the absorption (1214) and emission spectra of frequency spectra of relmapirazin (also referred to as MB-102) (1215), an exogenous fluorescent agent in one aspect. Emission spectra for a blue LED light source 1211 and a green LED light source 1212 are also shown superimposed over the other spectra of FIG. 7. In this aspect, the system can include a blue LED as the first light source 218, and the excitatory wavelength for the system can be the isosbestic wavelength of about 450 nm. As shown in FIG. 7, the Hb absorbance spectra is strongly sloped at the isosbestic wavelengths of about 420 nm to about 450 nm, indicating that the relative absorbance of (HbO₂) (1217) and (Hb) (1216) at the isosbestic wavelength of about 450 nm is sensitive to small changes in excitatory wavelength. However, at wavelengths above about 500 nm, the (HbO₂)/(Hb) spectra are less steeply sloped, and a broader band light source including, but not limited to, an LED with a bandpass filter 1213 can suffice for use as a first light source.

In another aspect, the excitatory wavelength can be selected to enhance the contrast in light absorbance between the exogenous fluorescent agent and the chromophores within the tissues of the patient. By way of non-limiting example, as shown in FIG. 7 at the isosbestic wavelength of 452 nm, the light absorption of the relmapirazin is more than three-fold higher than the light absorption of the (HbO₂) and the (Hb). Without being limited to any particular theory, a higher proportion of light illuminating the tissue of the patient at a wavelength of about 450 nm will be absorbed by the relmapirazin relative to the (HbO₂) and (Hb), thus enhancing the efficiency of absorption by the relmapirazin and reducing the intensity of light at the excitatory wavelength needed to elicit a detectable fluorescence signal.

In various aspects, a second isosbestic wavelength can also be selected as the emission wavelength for the system. By way of non-limiting example, FIG. 7 shows an emission spectrum of the relmapirazin exogenous contrast agent (1215) that is characterized by an emission peak at a wavelength of about 550 nm. In this non-limiting example, the isosbestic wavelength of 570 nm can be selected as the emission wavelength to be detected by first and second detectors. In various other aspects, the emission wavelength of the system can be selected to fall within a spectral range characterized by relatively low absorbance of the chromophores within the tissues of the patient 202. Without being limited to any particular theory, the low absorbance of the chromophores at the selected emission wavelength can reduce the losses of light emitted by the exogenous fluorescent agent and enhancing the efficiency of fluorescence detection.

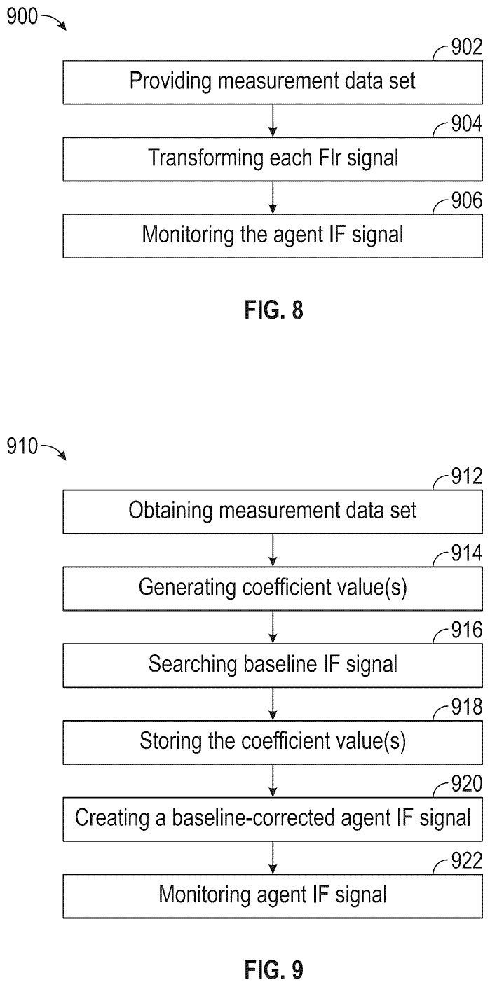

Combining at least one DR signal with the Flr signal in a transformation relation may produce an intrinsic fluorescence (IF) signal that is representative of the fluorescence from the agent independent of the influence of time-varying optical properties. FIG. 8 illustrates a flow chart 900 corresponding to a method of monitoring time-varying fluorescence emitted from an exogenous fluorescent agent from within a diffuse reflecting medium with time-varying optical properties. The method as described in FIG. 8 can make use of the above described device and/or system. The steps outlined herein are non-limiting examples provided for illustration purposes, and can be implemented in any combination thereof, including combinations that exclude, add, or modify certain steps.

At block 902, the method 900 can provide a measurement data set comprising a plurality of measurement entries. The plurality of measurement entries comprising at least two measurements obtained at each data acquisition time from a patient before and after administration of the exogenous fluorescent agent. The at least two measurements comprising: at least one diffuse reflectance (DR) signal and at least one fluorescence emission (Flr) signal. In at least one example, the at least one DR signal comprises a diffuse reflectance signal at an excitation wavelength of the exogenous fluorescent agent (DRₑₓ), and a diffuse reflectance signal at an emission wavelength of the exogenous fluorescent agent (DRₑₘ). In at least one example, the at least two DR signals comprise a diffuse reflectance signal at an excitation wavelength of the exogenous fluorescent agent (DRₑₓ), and a diffuse reflectance signal at an emission wavelength of the exogenous fluorescent agent (DRₑₘ).

At block 904, the method 900 can transform each Flr signal of each measurement data entry of the measurement data set to an agent intrinsic fluorescent (IF) signal representing a detected fluorescence intensity emitted by the exogenous fluorescent agent from within the diffuse reflecting medium. The transformation of the DR and Flr signals to determine the IF signal comprises periodically combining the at least two measurements according to a transformation relation comprising at least one variable pathlength factor for the at least one DR signal. In at least one aspect, the at least one pathlength factor for the at least one DR signal represents the optical pathlength for the at least one DR signal in the tissue relative to the optical pathlength for the fluorescence signal in the tissue. Variation of the pathlength factor can help to improve the accuracy of the computed IF, for example, by better accounting for variations in tissue optical properties.

The pathlength that the excitation light travels through the tissue from the light source to the exogenous fluorescent agent and the pathlength that the resultant fluorescence emission light travels from the exogenous fluorescent agent to the light detector will affect the fluorescence intensity that is measured. These pathlengths may be influenced by the sensor geometry, particularly the source-detector separation, as well as the optical properties of the tissue. Variations in tissue optical properties over the time period of renal clearance of the exogenous fluorescent agent influences the quantification of the exogenous fluorescent agent clearance rate. In one aspect, the tissue optical properties most expected to vary over the time period of clearance of the exogenous fluorescent agent relmapirazin are the local hemoglobin content of tissue and the local water concentration. In the visible spectral region (where relmapirazin absorbs and fluoresces), hemoglobin variation primarily leads to changes in the absorption coefficient, while water variation is more closely associated with changes in the scattering coefficient. To improve the accuracy of the measurement of the renal clearance rate, correcting for these pathlength differences is therefore beneficial, particularly when using only a limited portion of the clearance curve, such as may be the case for a real-time continuous assessment of GFR.

In at least one aspect, allowing the pathlength factor for DRₑₓ and DRₑₘ to vary independently results in a codependence of the two pathlengths and therefore a noisy IF signal. In another aspect, constraining the pathlengths to a fixed sum or ratio may alleviate the codependence, and produce a more stable IF signal. In at least one aspect, the present disclosure includes what is described in Example 1 below.

In at least one example, wherein the pathlengths for DRₑₓ (either DRₑₓ₁ or DR_{ex,corr}, defined below) and DRₑₘ are constrained to a fixed sum, the transformation of the Flr signal to the agent IF signal comprises dividing Flr by a product of (DRₑₘ)^{Kem} and (DRₑₓ)^{(c-Kem)}, where c is a constant and Kₑₘ is determined by a fit that minimizes a variation of the agent IF signal. In an example, the relationship can be described as Kₑₓ=c-Kₑₘ. An example of Kₑₘ is described in Example 1. The fit is defined by fitting function:

$$log ( F l r ) - c log ( D {R}_{e x} ) = log ( IF ) + kem ( log ( D {R}_{e m} ) - log ( D {R}_{e x} ) )$$

and a linear fit is performed wherein an independent variable is log(DRₑₘ)−log(DRₑₓ) and a dependent variable is log(Flr)−c log(DRₑₓ) whereby an offset term from the linear fit is log(IF). An example is further provided in relation to Example 2 below.

In at least one example, wherein the pathlengths for DRₑₓ and DRₑₘ are constrained to a fixed ratio, the transformation of the Flr signal to the agent IF signal comprises dividing Flr by a product of (DRₑₘ)^{Kem} and (DRₑₓ)^{(r*Kem)}, where r is a constant and Kₑₘ is determined by a fit that minimizes a variation of the agent IF signal. The fit can be defined by a fitting function, which is:

$$log ( F l r ) = log ( IF ) + K e m ( log ( D {R}_{e m} ) - r log ( D {R}_{e x} ) )$$

And a linear fit is performed wherein an independent variable is log(DRₑₘ)−rlog(DRₑₓ) and a dependent variable is log(Flr) whereby an offset term from the linear fit is log(IF). In at least one example in the fixed sum method, the constant c is between 0.9 and 1.8. Additional information is provided in relation to Examples 1 and 2. In at least one example, the constant c is 1.15. In at least one example in the fixed ratio method, the constant r is between 0.05 and 0.3. In at least one example, the constant r is 0.15. As discussed above, the c and r values may be affected by sensor geometry, particularly the source-detector separation. Additionally, Example 3 provides an example implementation.

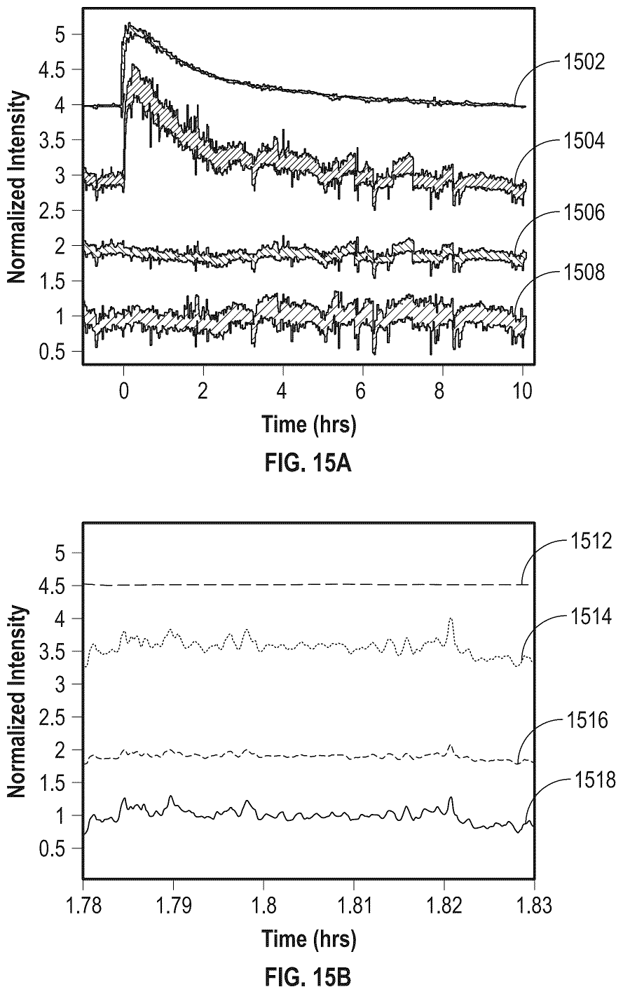

The pathlength factors are determined by minimizing the variation of the resultant IF. In at least one example, the at least one variable pathlength factor is re-determined periodically. In at least one example, the method 900 can include a period for re-determining the pathlength factor between 1 second and 10 minutes. In at least one example, the method 900 can include a period for re-determining the pathlength factor of about 30 seconds. In at least one example, the method 900 can include a period for re-determining the pathlength factor adjusted according to most recent estimate of a renal function of the patient, wherein the period is kept short enough so that renal clearance of the agent is minimal (i.e. no variation in the IF signal) but kept long enough to observe variations in tissue optical properties (i.e. correlated across the Flr and DR signals) and thereby allow for accurate determination of the pathlength factors. A graphical example is provided in Example 4. The present disclosure can involve analysing the tissue noise, over short time scales (for example 30 seconds), in the Flr and Dr signals and correlations across the Flr and Dr signals. In the example, the variation in the IF signal on the time scale is small to non-existent. As illustrated in FIG. 15B, the IF signal is substantially flat. The pathlength factors can be determined by minimizing the variation of the resultant IF signal.

In at least one example of the method 900, the transformation of the Flr signal to an IF signal comprises dividing Flr by DR^{K}, where K is determined by a fit that minimizes a variation of the agent IF signal during the period of the fit. In at least one example, the fit can be defined by a fitting function that can be: log(Flr)=log(IF)+K log(DR) and a linear fit is performed wherein an independent variable is log(DR) and a dependent variable is log(Flr) whereby an offset term from the linear fit is log(IF). In at least one example, the at least one DR signal comprises a diffuse reflectance signal at an emission wavelength (DRₑₘ) of the fluorescent agent.

At block 906, the method 900 can monitor an agent IF signal for each measurement data entry within the measurement data set. The fluorescence emission of the agent can be determined with reduced sensitivity to the time-varying optical properties of the medium.

Autofluorescence, light leakage and other extraneous factors may influence the Flr signal. Prior to administering the exogenous fluorescent agent, Flr signals which include fluorescence due to tissue autofluorescence are measured during the baseline period. The baseline period, as used herein, refers to an initial time period of measurements obtained prior to administration of the exogenous fluorescent agent. In at least one example, the baseline fluorescence is subtracted from the fluorescent signal measurements after agent administration. In at least one aspect, variations in tissue optical properties can cause fluorescence signals to increase and decrease around the nominal baseline value over time. Further, patient re-positioning, manipulation of other sensors (e.g. ECG electrodes), and preparation for agent administration may influence the baseline signal. The influence of these factors may be mitigated by the methods disclosed herein.

FIG. 9 illustrates a flow chart 910 corresponding to a method of monitoring time-varying fluorescence emitted from an exogenous fluorescent agent from within a diffuse reflecting medium with time-varying optical properties. The method as described in FIG. 9 can make use of the above described device and/or system. The steps outlined herein are non-limiting examples provided for illustration purposes, and can be implemented in any combination thereof, including combinations that exclude, add, or modify certain steps.

After administration of the exogenous fluorescent agent, the influence of optical variations on the endogenous and exogenous fluorescence signal components is hard to separate. In at least one example, the method 910 overcomes this by establishing calibration coefficients during the baseline period that are used are then used during the post-agent administration period to separately predict and remove the endogenous fluorescence. At block 912, the method 910 can obtain a measurement data set comprising a plurality of measurement entries comprising at least two measurements obtained at one data acquisition time from a patient before and after administration of the exogenous fluorescent agent, the at least two measurements comprising: a diffuse reflectance (DR) signal and a fluorescence emission (Flr) signal. In at least one example, the DR measurement comprises at least two DR measurements at different wavelengths, one corresponding to an excitation wavelength of the exogenous fluorescence agent (DRₑₓ) and another at an emission wavelength of the exogenous fluorescent agent (DRₑₘ). In at least one example, the DRₑₘ measurement comprises at least two measurements at an emission wavelength of the exogenous fluorescence agent, a first measurement using a detector which is not optically filtered (DR_{em,unfiltered}) and a second measurement using a detector which is optically filtered (DR_{em,filtered}).

At block 914, the method 910 can generate at least one coefficient value for combining the DR and Flr signals from at least a portion of the measurement data set obtained prior to administration of the exogenous fluorescent agent to calculate a baseline intrinsic fluorescence (IF) signal. In at least one example, the at least one coefficient value comprises a plurality of fitting coefficients between DR and Flr. Example 3 provides for some additional equations, namely equations 2a-c. In at least one example, the at least one coefficient value comprises a plurality of factors for individually normalizing the Flr and DR signals to 1 during a baseline period.

At block 916, the method 910 can search for the baseline IF signal having a minimum variance and constrained to a maximum drift over a predetermined time window. In at least one example, the method 910 can determine if the minimum variance is above a limit. In at least one example, the method 910 can, when variance is not above the limit, determine if drift in the IF signal is less than a predetermined value and, if so, to update the stored coefficients. In at least one example, the predetermined time window is five minutes. A further example is provided in Example 3. Additionally, in at least one example, once a baseline is determined, the method can continue to calculate one or more new baselines. The one or more new baselines can be compared to the stored baseline. If the noise in the one or more new baselines is lower than the stored baseline, the stored baseline is updated to be that of the one or more new baselines that has lower noise. Furthermore, the signal normalization factors, as described in Example 3, can be updated in the memory of the system.

At block 918, the method 910 can store the at least one coefficient value.

At block 920, the method 910 can create a baseline-corrected agent IF signal by combining the stored at least one coefficient value with the Flr and DR signals collected after administration of the fluorescence agent. Example 3 provides an example of the creation of the baseline-corrected agent IF signal. In at least one example, the present disclosure includes determining and/or detecting an injection of the agent. The method can stop updating the baseline period and normalization factors. The stored signal normalization factors can be applied prospectively to newly acquired (for example, post agent detection) signals, and computing the IF using the resulting signals. Additionally, in at least one example, the method can include going back a predetermined period of time. In at least one example, the predetermined period of time is five minutes.

At block 922, the method 910 can monitor the agent IF signal for each measurement data entry within a post-agent-administration portion of the measurement data set, whereby the fluorescence emission of the agent is determined with reduced sensitivity to the time-varying optical properties of the medium.

The method 910 may be useful in preventing administration of an exogenous fluorescent agent during monitoring a biological parameter indicative of organ function in a patient until a stable baseline signal has been achieved. For example, if the baseline signal is drifting or noisy, the method of monitoring does not proceed until the issue has been resolved. In addition, by continually checking, and when appropriate, updating, the baseline calculation, the cleanest baseline period is identified, and noisy baseline segments are excluded from the baseline calculation.

Although the first unfiltered light detector 322 of FIG. 2 is configured to detect both excitation-wavelength and emission-wavelength light of the exogenous fluorescent agent, the intensity of the excitation-wavelength light may be orders of magnitude higher than the intensity of the emission-wavelength light as a result of the lower efficiency of producing light via fluorescence. In various aspects, the proportion of emission-wavelength light within DRex is assumed to be negligible. In other aspects, a proportion of emission-wavelength light combines with the DRₑₓ and can be separated to provide a corrected DRₑₓ (DR_{ex, corr}).

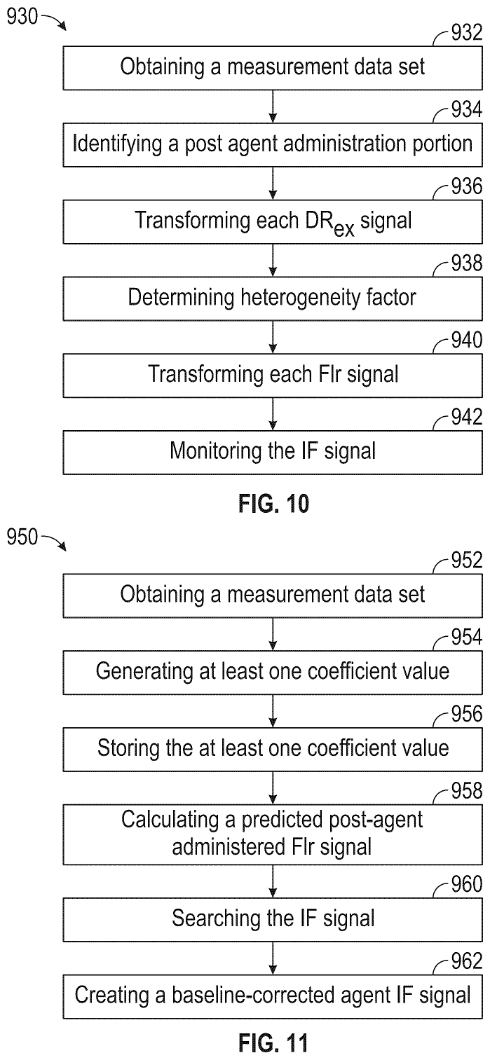

FIG. 10 illustrates a flow chart 930 corresponding to method of monitoring time-varying fluorescence emitted from an exogenous fluorescent agent from within a diffuse reflecting medium with time-varying optical properties. The method as described in FIG. 10 can make use of the above described device and/or system. The steps outlined herein are non-limiting examples provided for illustration purposes, and can be implemented in any combination thereof, including combinations that exclude, add, or modify certain steps.

At block 932, the method 930 can provide a measurement data set comprising a plurality of measurement entries comprising at least four measurements obtained at one data acquisition time from a patient before and after administration of the exogenous fluorescent agent, the at least four measurements comprising: a diffuse reflectance signal at an emission wavelength of the fluorescent agent measured on a first detector that is not optically filtered (DR_{em,unfiltered}); a diffuse reflectance signal at an emission wavelength of the fluorescent agent measured on a second detector that is optically filtered (DR_{em,filtered}); a diffuse reflectance signal at an excitation wavelength (DRₑₓ) of the fluorescent agent measured on the first detector; and a fluorescence emission signal (Flr) measured on the second detector. Additional example information is provided in FIGS. 2-3.

At block 934, the method 930 can identify a post-agent-administration portion of the measurement data set.

At block 936, the method 930 can transform each DRₑₓ signal of each measurement data entry of the measurement data set to a DR_{ex,corr} signal by combining the DRₑₓ signal with the DR_{em,filtered}, DR_{em,unfiltered}, Flr signals and a heterogeneity factor to reduce a Flr contribution to the DRₑₓ signal. In at least one example, the method 930 can transform the DRₑₓ signal by combining terms according to: DR_{ex,corr}=Ghc×DRₑₓ=DR_{em,filtered}/DR_{em,unfiltered}−Flr.

At block 938, the method 930 can determine the heterogeneity factor by comparing the DR_{ex,corr} signal before and after the agent administration. In at least one alternate example, the heterogeneity factor is determined by minimizing a deviation of the DRₑₓ signal resulting from the administration of the fluorescent agent. In yet another alternate example, the heterogeneity factor is determined using a time window spanning 15 minutes before and 15 minutes after administration of the fluorescent agent. In yet another example, the determined value of the heterogeneity factor is compared to at least one threshold that is used to determine validity of the measurement.

At block 940, the method 930 can transform each Flr signal of each measurement data entry of the measurement data set to an intrinsic fluorescent (II) signal representing a detected fluorescence intensity emitted by the exogenous fluorescent agent from within the diffuse reflecting medium, wherein transforming the the Flr signal comprises combining the Flr, DR_{em,filtered} and DR_{ex,corr} signals.

At block 942, the method 930 can monitor the IF signal for each measurement data entry within the measurement data set, whereby the fluorescence emission of the agent is determined with reduced sensitivity to the time-varying optical properties of the medium.

FIG. 11 illustrates a flow chart 950 corresponding to a method of correcting baseline data in monitoring time-varying fluorescence emitted from an exogenous fluorescent agent. The method as described in FIG. 11 can make use of the above described device and/or system. The steps outlined herein are non-limiting examples provided for illustration purposes, and can be implemented in any combination thereof, including combinations that exclude, add, or modify certain steps.

At block 952, the method 950 can obtain a measurement data set comprising a plurality of measurement entries comprising at least two measurements obtained at one data acquisition time from a patient before and after administration of the exogenous fluorescent agent, the at least two measurements comprising: a diffuse reflectance (DR) signal and a fluorescence emission (Flr) signal.

At block 954, the method 950 can generate at least one coefficient value for predicting a Flr baseline signal from the DR signal, wherein the at least one coefficient value is established using a correlation between the DR signal and Flr signal.

At block 956, the method 950 can store the at least one coefficient value.

At block 958, the method 950 can calculate a predicted post-agent administered Flr signal using the at least one coefficient value.

At block 960, the method 950 can calculate an intrinsic fluorescence (IF) signal.

At block 962, the method 950 can create a baseline-corrected agent IF signal by subtracting an auto-fluorescence contribution based on the predicted post-agent administer Flr signal from the calculated IF signal.

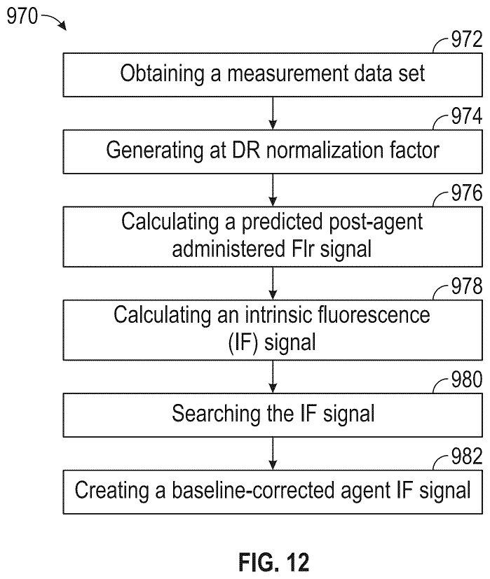

FIG. 12 illustrates a flow chart 970 corresponding to a method of correcting baseline data in monitoring time-varying fluorescence emitted from an exogenous fluorescent agent. The method as described in FIG. 12 can make use of the above described device and/or system. The steps outlined herein are non-limiting examples provided for illustration purposes, and can be implemented in any combination thereof, including combinations that exclude, add, or modify certain steps.

At block 972, the method 970 can obtain a measurement data set comprising a plurality of measurement entries comprising at least two measurements obtained at one data acquisition time from a patient before and after administration of the exogenous fluorescent agent, the at least two measurements comprising: a diffuse reflectance (DR) signal and a fluorescence emission (Flr) signal.

At block 974, the method 970 can generate a DR normalization factor to normalize a baseline DR signal to a central value of 1.

At block 976, the method 970 can calculate a predicted post-agent administered Flr signal using the at least one coefficient value.

At block 978, the method 970 can calculate an intrinsic fluorescence (IF) signal.

At block 980, the method 970 can search the IF signal having a minimum variance and constrained to a maximum drift over a predetermined time window.

At block 982, the method 970 can create a baseline-corrected agent IF signal by subtracting 1 from the calculated IF signal.

While each of the above methods have been described individually, the present application provides for combining one or more features of each of the methods with the other. Four additional examples are presented herein to provide additional details and illustrative description.

### Example 1: Interpretation of Pathlength Factors and their Dependencies

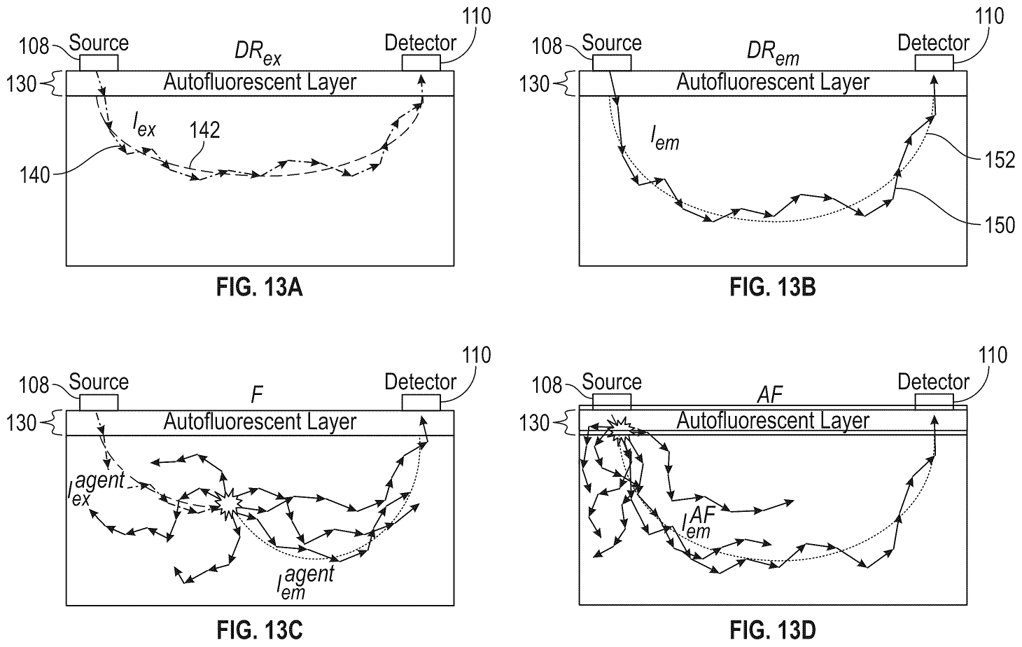

FIGS. 13A-D provide depiction of optical pathlengths traveled through tissue by fluorescent (F, AF) and diffuse reflected (DR) light. As illustrated FIGS. 13A-D include a source 108 and detector 110. Additionally, an autofluorescent layer 130 is included. As illustrated FIG. 13A presents diffuse reflectance excitation (DRₑₓ), FIG. 13B presents diffuse reflectance emission (DRₑₘ), FIG. 13B presents extrinsic agent (F), and FIG. 13D presents intrinsic fluorescent (AF). The optical pathlength factor, Kₑₓ, in an example aspect of the disclosure, represents a ratio of a pathlength,

$${l}_{e x}^{a gent} ,$$

(FIG. 13C), traveled unrougn tissue by light that excites a fluorescent molecule, to the pathlength, lₑₓ (140) with a predicated path of 142, traveled by light at the same wavelength that travels all the way to the detector without interacting with a fluorescent agent. Similarly, the optical pathlength factor, Kₑₘ, represents a ratio of a pathlength,

$${l}_{e m}^{a gent} ,$$

(FIG. 13C), traveled through tissue by fluorescence light emitted by a fluorescent molecule, to the pathlength, lₑₘ (150), with a predicated path of 152, traveled by light at the same emission wavelength that travels all the way to the detector without interacting with a fluorescent agent. The fluorescent molecule may be intrinsic to the tissue (represented as AF in FIG. 13D) or may be an extrinsic agent (represented as F in FIG. 13C). The typical depths at which these molecules are located within the tissue may differ. For example, as depicted in FIG. 13D, the intrinsic fluorescent (AF) molecules may more typically reside near the surface of the skin, in or near the epidermis, while the extrinsic fluorescent agent (F), FIG. 13C, may more typically reside deeper in the skin, such as within the dermis. This difference in the tissue depth of the AF and F signals can result in a difference in the pathlength factors that may need to be accounted for in order to most accurately compute the Intrinsic Fluorescence (IF). The pathlengths factors can also be affected by variation in optical absorption within the skin, such as due to melanin and blood content, as well as by variations in the optical scattering of the tissue. Some of these factors (for example, melanin content of the skin) are expected to vary from subject-to-subject but be relatively invariant on the time scale (hours) of renal clearance measurements. Others of these factors, particularly local blood content of the skin, can vary within each subject on more rapid time scales (seconds). For example, local oscillations in skin blood content are commonly observed on a time scale of seconds, due to opening and closing of blood vessels. Variation in the force applied to a sensor on the surface of the skin, such as caused by movement of the patient, can also lead to variation in the underlying local blood and fluid content. As a result of the optical property variations, in different aspects of the invention, the pathlength factors may be adjusted either on a patient-by-patient basis or more dynamically within the time course of the renal clearance of an extrinsic agent.

### Example 2: Optimization of Pathlength Factors to Minimize Variation in IFₐᵤₜₒ

In a second example, autofluorescence signals measured on the skin of 14 human subjects was measured by a sensor of the present invention. The Kₑₘ and Kₑₓ terms in Eqn. 1 were fitted independently to minimize the variation and drift of the IF signal over time.

$$IF = \frac{F l r}{D {R}_{e m}^{K e m} D {R}_{e x}^{K e x}} \qquad ( Eqn . 1 )$$

The resulting fitted terms were found to be correlated to each other, and this co-dependence contributed to greater noise and drift in the resultant IF than if only one of the DR terms was used alone. Assuming a nearly constant total path of the light traveled from source to detector, an increase in the pathlength of fluorescence excitation light to a fluorophore is expected to lead to a decrease in the pathlength of fluorescence emitted by the fluorophore. By fitting to the sum of the pathlength factors, Kₑₓ+Kₑₘ, the IF variation and drift were reduced. This summed pathlength factor was found to be nearly constant across subjects. In one aspect of the present invention, the summed pathlength factors is determined on a patient-by-patient basis, by minimizing the variation of the resultant IF signal during a baseline period (i.e. prior to introduction of an extrinsic agent).

### Example 3: Effect of Sensor Geometry on Pathlength Factor Optimization

In a third example, the effect of sensor geometry on the pathlength factors was explored. Two sensor types were constructed from the same optical and electronic components but with slightly different configurations of optical apertures. The nearest edge of the source and detector apertures was about 30% closer for Config B compared to Config A.

A clinical study was conducted on 8 subjects screened to have eGFR>60 mL/min/1.73 m² and monitored for about 12 hours, with injection of the fluorescent agent, relmapirazin, occurring about half an hour into the monitoring session. The median of the baseline (pre-injection) sensor signals (Flr, DRₑₓ, DRₑₘₗ, and DRₑₘ₂) was computed over a 3 minute window. Baseline validity was determined by using the tentative baseline signals computed over the window to calculate an IF signal, and then computing the mean, variance, and drift. The tentative baseline window was considered to be valid if the standard deviation of the computed IF was below a threshold of 1.6% of the mean and the drift of IF over the first and second halves of a 5 minute period was below 0.6% of the mean. In at least one example, if the standard deviation was below a threshold of 5% of the mean, the present disclosure can proceed. Additionally, if the drift was less than 1% of the mean, the method could continue. This process was repeated over the baseline period, up until 5 minute prior to agent injection, and the baseline was updated if the noise in the IF signal computed from a new baseline window was lower than the previously stored baseline window. The software workflow did not allow the user to proceed to agent injection until a valid baseline was accepted. The following normalization factors were determined from the signals measured over the final valid baseline window with f being a function that generates a single value from an array of values, like e.g. the mean, the median or various filters like e.g. a boxcar filter:

$$N o r {m}_{D R e m} = \frac{1}{f ( D {R}_{e m 2} )} \qquad ( Eqn . 2 a )$$

$$Nor {m}_{D R e x} = \frac{1}{f ( D {R}_{e x 2} )} \qquad ( Eqn . 2 b )$$

$$Nor {m}_{F l r} = \frac{1}{f ( D {R}_{F l r} )} \qquad ( Eqn . 2 c )$$

These normalization factors were multiplied by all subsequent measurements of the corresponding sensor signals such that the signals were nominally 1 during the baseline period. The Flr signal increased above 1 after agent injection, whereas DRₑₓ and DRₑₘ signals remained approximately at a level of 1 across the full measurement session. Variations in tissue optical properties over the course of the agent clearance caused signals to increase and decrease around the nominal baseline value over time. The DRₑₓ and DRₑₘ signals were used to correct for the effect of this tissue variation on the Flr signal by combining them using Eqn. 1.

Several minutes after the agent was injected, an algorithm was used to remove the fluorescence emission contribution to the measured diffuse reflectance signal at the excitation wavelength (DRₑₓ). The conceptual basis for the algorithm is that the “clean” DRₑₓ signal should be unaffected by the injection of the fluorescent agent, so that comparisons of DRₑₓ across time segments that span the pre-and post-injection periods can be used to assess and remove the fluorescence contribution. In this example, the cleaned DRₑₓ signal, DRₑₓ₂, was computed using:

$$D {R}_{e x 2} = {G}_{h c} \times D {R}_{e x 1} \times \frac{D {R}_{e m 2}}{D {R}_{e m 1}} - F l {r}_{2} \qquad ( Eqn . 3 )$$

where Gₕₑ represents the “heterogeneity constant” chosen as the value from the discrete set (0.05-3.0), in steps of 0.05, that produces the best linear fit between DRₑₘ₂ and DRₑₓ₂. In other examples, Gₕₑ can be a predetermined constant. The predetermined constant value can range from 0 to 5.

The intrinsic fluorescence was computed using Eqn. 1, with normalized Flr₂, normalized DRₑₘ₂, and normalized DRₑₓ₂ used as the Flr, DRₑₘ, DRₑₓ signals, respectively. A value of 1 was subtracted from the resultant IF signal to remove the baseline autofluorescence contribution. In other examples, each of Flr₂, DRₑₘ₂, and DRₑₓ₂ can remain non-normalized and used as the Flr, DRₑₘ, DRₑₓ signals, respectively. In at least one example, the non-normalized Flr₂, DRₑₘ₂, and DRₑₓ₂ are usted during the baseline calculation. The Kₑₘ and Kₑₓ terms were determined at 30 second intervals by fitting them under the constraint that they sum to a constant value, (C, as shown in Eqn. 4:

$$IF = \frac{F l {r}_{2}}{D {R}_{e m 2}^{K e m} {DR}_{ex 2}^{( C - Kem )}} \qquad ( Eqn . 4 )$$

For each test of nGFR accuracy described below, the sum of the pathlength factors, C, was kept the same across all IF measurements and subjects. The resultant IF signal was fitted to a single exponential function between 2 and 5 hours (relative to the time of agent injection). The rate constant (in inverse minutes) from the exponential fit was multiplied by a constant value (13,561) to convert it into a prediction of nGFR (GFR normalized to volume of distribution). Simultaneously with the optical measurements, plasma samples were periodically collected from each subject and the relmapirazin concentrations in the plasma were determined by HPLC. The time course of plasma relmapirazin concentrations was used to determine a reference nGFR value for comparison to the trans-cutaneous predictions. Standard errors of prediction (SEP) between the predicted and reference nGFRs were computed across all 8 study subjects, using different values for the summed pathlength factor, C. Sensor Config A gave a minimum SEP with C set to 1.15, whereas sensor Config B the minimum with C set to 1.3.

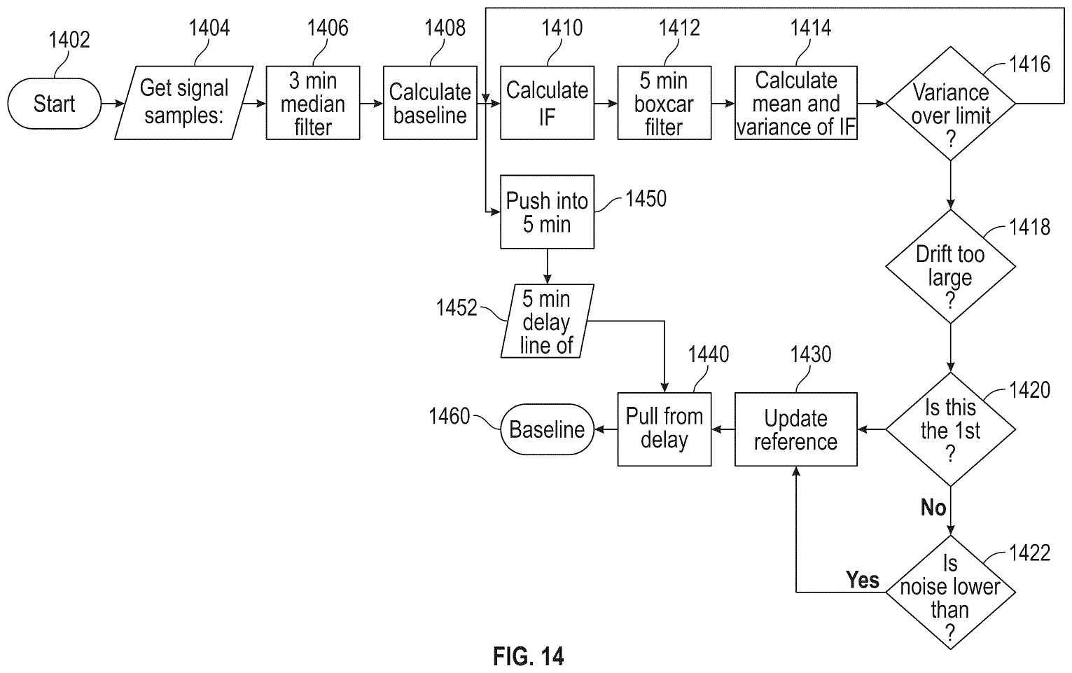

FIG. 14 provides an example of a baseline calculation flow chart. At block 1402, the method can have a start function. At block 1404, the method can get signal samples. At block 1406, the method can apply a three minute median filter. At block 1408, the method can calculate a baseline. The flow can continue to block 1410 to calculate IF signal or alternatively to block 1450 to push into the sample data five minutes. At block 1412, the method can apply a five minute boxcar filter. At block 1414, the method can calculate mean and variance of the IF signal. At block 1416, the method can determine if the variance is over the limit. If the variance is not over the limit, at block 1418, the method can determine if the drift is too large. If the variance was over the limit, the method can return to before block 1410 and block 1450. The method can continue to block 1420 if the drift is not too large. At block 1420, the method can determine if this calculation is the first baseline. If this is not the first baseline, the method can continue to determine if the noise is lower than the prior baselines at block 1422. If this is the first baseline, the method at block 1430 updates the reference. The method at block 1440 can pull from the delay and the method at block 1460 can generate the baseline.

The method can flow from block 1450 to block 1452 to provide a five minute delay line.

### Example 4: Comparison of the Time Window used for Pathlength Factor Optimization with the Time Scale of Relmapirazin Renal Clearance

In a fourth example, the signals from a sensor of the present invention, measured on a patient injected with relmapirazin, are compared on different time scales. The data are from one of the subjects in the study described above under Example 3, and the data processing and algorithms were also as described in that example. FIG. 15A illustrates Transcutaneous Fluorescence (Flr) 1504, Diffuse Reflectance (DR) 1506, 1508, and Intrinsic Fluorescence (IF) 1502 as a function of time for a human subject injected with relmapirazin at time 0, displayed over time spans of about 11 hours. FIG. 15B illustrates Transcutaneous Fluorescence (Flr) 1514, Diffuse Reflectance (DR) 1516, 1518, and Intrinsic Fluorescence (IF) 1512 as a function of time for a human subject injected with relmapirazin at time 0, displayed over time spans of about 180 seconds. FIG. 15A shows the time course of the full measurement period for renal clearance of the relmapirazin agent. The DRₑₘ 1506, DRₑₓ 1508, and FIr 1504 signals are shown overlaid and offset from the computed IF signal 1502 from which nGFR was determined. For this subject, having normal renal function, the IF signal indicates that the relmapirazin has been practically fully cleared from the body within 10 hours following its injection. To dynamically correct for pathlength variations over the course of this renal clearance curve, a period must be selected that is short enough so that the IF change is negligible, while also keeping the period long enough so that strong correlation can be established between the Flr and DR signals. A zoomed-in portion of the full renal decay curve, provided in FIG. 15B, demonstrates both of these aspects: the IF signal 1512 shows no observable decrease on this time scale, while the high correlation between the noise in the Flr 1504 and DR signals 1506, 1508 is evident by their similar response to tissue optical perturbations on the time scale of seconds.

In one aspect of the present disclosure, the transcutaneously assessed GFR is used to automatically extend the allowed window length used for calculation of the pathlength factor. Extending the allowed window length may result in improved correlation between the Flr and DR signals, thereby resulting in a lower noise IF signal. In another aspect of the invention the noise of the IF signal resulting from a range of window lengths is assessed, and the length resulting in the lowest noise is selected.

Illustrative aspects of the disclosure include:

Aspect 1. A method of monitoring time-varying fluorescence emitted from an exogenous fluorescent agent from within a diffuse reflecting medium with time-varying optical properties, the method comprising: providing a measurement data set comprising a plurality of measurement entries comprising at least two measurements obtained at each data acquisition time from a patient that is administered the exogenous fluorescent agent, the at least two measurements comprising: at least one diffuse reflectance (DR) signal and at least one fluorescence emission (Flr) signal; transforming each Flr signal of each measurement data entry of the measurement data set to an agent intrinsic fluorescent (IF) signal representing a detected fluorescence intensity emitted by the exogenous fluorescent agent from within the diffuse reflecting medium, wherein transforming the Flr signal comprises periodically combining the at least two measurements according to a transformation relation comprising at least one variable pathlength factor for the at least one DR signal, wherein the at least one variable pathlength factor is re-determined periodically; monitoring the agent IF signal for each measurement data entry within the measurement data set, whereby fluorescence emission of the agent is determined with reduced sensitivity to the time-varying optical properties of the medium.

Aspect 2. The method of aspect 1, wherein the at least one DR signal comprises a diffuse reflectance signal at an excitation wavelength of the exogenous fluorescent agent (DRex) and a diffuse reflectance signal at an emission wavelength of the exogenous fluorescent agent (DRem).

Aspect 3. The method of aspect 2, wherein transforming the Flr signal to the agent IF signal comprises dividing Flr by a product of (DRₑₘ)^{Kem} and (DRₑₓ)^{(c-Kem}), where c is a constant and Kₑₘ is determined by a fit that minimizes a variation of the agent IF signal.

Aspect 4. The method of aspect 3, wherein the fit is defined by fitting function:

log(Flr)−c log(DRₑₓ)=log(IF)+kem(log(DRₑₘ)−log(DRₑₓ)) and a linear fit is performed wherein an independent variable is log(DRₑₘ)−log(DRₑₓ) and a dependent variable is log(Flr)−c log (DRₑₓ) whereby an offset term from the linear fit is log(IF).

Aspect 5. The method of aspect 2, wherein transforming the Flr signal to the agent IF signal comprises dividing Flr by a product of (DRₑₘ)^{Kem} and (DRₑₓ)^{(r*Kem}), where r is a constant and Kₑₘ is determined by a fit that minimizes a variation of the agent IF signal.

Aspect 6. The method of aspect 5, wherein the fit is defined by a fitting function, which is:

$$log ( Fl r ) = log ( IF ) + kem ( log ( D {R}_{e m} ) - r log ( D {R}_{e x} ) )$$

and a linear fit is performed wherein an independent variable is log (DRₑₘ)−rlog(DRₑₓ) and a dependent variable is log(Flr) whereby an offset term from the linear fit is log(IF).

Aspect 7. The method of aspect 4, wherein the constant c is between 0.9 and 1.8.

Aspect 8. The method of aspect 4, wherein the constant c is 1.15.

Aspect 9. The method of aspect 5, wherein the constant r is between 0.05 and 0.3.

Aspect 10. The method of aspect 5, wherein the constant ris 0.15.

Aspect 11. The method of any one of aspects 1-10, wherein the period for re-determining the pathlength factor is between 1 second and 10 minutes.

Aspect 12. The method of any one of aspects 1-10, wherein the period for re-determining the pathlength factor is 30 seconds.

Aspect 13. The method of any one of aspects 1-10, wherein the period for re-determining the pathlength factor is adjusted according to most recent estimate of a renal function of the patient, wherein the period is kept short enough so that renal clearance of the agent is minimal but kept long enough to allow for accurate determination of the pathlength factors.

Aspect 14. The method of any one of aspects 1-13, wherein transforming the Flr signal to an IF signal comprises dividing Flr by DR^{K}, where K is determined by a fit that minimizes a variation of the agent IF signal during the period of the fit.

Aspect 15. The method of aspect 14, wherein fit can be defined by a fitting function that is: log(Flr)=log(IF)+K log(DR)

and a linear fit is performed wherein an independent variable is log(DR) and a dependent variable is log(Flr) whereby an offset term from the linear fit is log(IF).

Aspect 16. The method of aspect 15, wherein the at least one DR signal comprises a diffuse reflectance signal at an emission wavelength of the fluorescent agent (DRₑₘ).

Aspect 17. A method of monitoring time-varying fluorescence emitted from an exogenous fluorescent agent from within a diffuse reflecting medium with time-varying optical properties, the method comprising: obtaining a measurement data set comprising a plurality of measurement entries comprising at least two measurements obtained at one data acquisition time from a patient before and after administration of the exogenous fluorescent agent, the at least two measurements comprising: a diffuse reflectance (DR) signal and a fluorescence emission (Flr) signal; generating at least one coefficient value for combining the DR and Flr signals from at least a portion of the measurement data set obtained prior to administration of the exogenous fluorescent agent to calculate a baseline intrinsic fluorescence (IF) signal; searching for the baseline IF signal having a minimum variance and constrained to a maximum drift over a predetermined time window; storing the at least one coefficient value of the baseline IF having the minimum variance and constrained to a maximum drift over the predetermined time window; creating a baseline-corrected agent IF signal by combining the stored at least one coefficient value with the Flr and DR signals collected after administration of the fluorescence agent; and monitoring the agent IF signal for each measurement data entry within a post-agent-administration portion of the measurement data set, whereby the fluorescence emission of the agent is determined with reduced sensitivity to the time-varying optical properties of the medium.

Aspect 18. The method of aspect 17, wherein the DR measurement comprises at least two DR measurements at different wavelengths, one corresponding to an excitation wavelength of the exogenous fluorescence agent (DRₑₓ) and another at an emission wavelength of the exogenous fluorescent agent (DRₑₘ).

Aspect 19. The method of aspect 18, wherein the DRem measurement comprises at least two measurements at an emission wavelength of the exogenous fluorescence agent, a first measurement using a detector which is not optically filtered (DR_{em,unfiltered}) and a second measurement using a detector which is optically filtered (DR_{em,filtered}).

Aspect 20. The method of any one of aspects 17-19, wherein the at least one coefficient value comprises a plurality of fitting coefficients between DR and Flr.

Aspect 21. The method of any one of aspects 17-19, wherein the at least one coefficient value comprises a plurality of factors for individually normalizing the Flr and DR signals to 1 during a baseline period.

Aspect 22. The method of any one of aspects 17-21, further comprising determining if the minimum variance is above a limit.

Aspect 23. The method of aspect 22, wherein the limit is below five percent.

Aspect 24. The method of aspect 23, wherein the limit is below 1.6 percent.

Aspect 25. The method of aspect 22, further comprising when variance is not above the limit, determining if drift in the IF signal is less than a predetermined value and, if so, to update the stored coefficients.

Aspect 26. The method of aspect 25, wherein the predetermined value is one percent.

Aspect 27. The method of aspect 25, wherein the predetermined time window is five minutes.

Aspect 28. A method of monitoring time-varying fluorescence emitted from an exogenous fluorescent agent from within a diffuse reflecting medium with time-varying optical properties, the method comprising: providing a measurement data set comprising a plurality of measurement entries comprising at least four measurements obtained at one data acquisition time from a patient before and after administration of the exogenous fluorescent agent, the at least four measurements comprising: a diffuse reflectance signal at an emission wavelength of the fluorescent agent measured on a first detector that is not optically filtered (DR_{em,unfiltered}); a diffuse reflectance signal at an emission wavelength of the fluorescent agent measured on a second detector that is optically filtered (DR_{em,filtered}); a diffuse reflectance signal at an excitation wavelength of the fluorescent agent measured on the first detector (DRₑₓ); and a fluorescence emission signal (Flr) measured on the second detector; identifying a post-agent-administration portion of the measurement data set; transforming each DRₑₓ signal of each measurement data entry of the measurement data set to a DR_{ex,corr} signal by combining the DRₑₓ signal with the DR_{em,filtered,} DR_{em,unfiltered}, Flr signals and a heterogeneity factor to reduce a Flr contribution to the DRₑₓ signal; determining the heterogeneity factor by comparing the DR_{ex,corr} signal before and after the agent administration; transforming each Flr signal of each measurement data entry of the measurement data set to an intrinsic fluorescent (IF) signal representing a detected fluorescence intensity emitted by the exogenous fluorescent agent from within the diffuse reflecting medium, wherein transforming the Flr signal comprises combining the Flr, DR_{em,filtered} and DR_{ex,corr} signals; monitoring the IF signal for each measurement data entry within the measurement data set, whereby the fluorescence emission of the agent is determined with reduced sensitivity to the time-varying optical properties of the medium.

Aspect 29. The method of aspect 28, wherein transforming of the DRₑₓ signal comprises combining terms according to: DR_{ex,corr}=Ghc×DRₑₓ×DR_{em,filtered/}DR_{em,unfiltered-}Flr, where Ghc is a predetermined constant.

Aspect 30. The method of any one of aspects 28-29, wherein the heterogeneity factor is determined by minimizing a deviation of the DRₑₓ signal resulting from the administration of the fluorescent agent.

Aspect 31. The method of any one of aspects 28-29, wherein the heterogeneity factor is determined using a time window spanning 15 minutes before and 15 minutes after administration of the fluorescent agent.

Aspect 32. The method of any one of aspects 28-29, wherein a determined value of the heterogeneity factor is compared to at least one threshold that is used to determine validity of the measurement.

Aspect 33. A method of correcting baseline data in monitoring time-varying fluorescence emitted from an exogenous fluorescent agent, the method comprising: obtaining a measurement data set comprising a plurality of measurement entries comprising at least two measurements obtained at one data acquisition time from a patient before and after administration of the exogenous fluorescent agent, the at least two measurements comprising: a diffuse reflectance (DR) signal and a fluorescence emission (Flr) signal; generating at least one coefficient value for predicting a Flr baseline signal from the DR signal, wherein the at least one coefficient value is established using a correlation between the DR signal and Flr signal; storing the at least one coefficient value; calculating a predicted post-agent administered Flr signal using the at least one coefficient value; calculating an intrinsic fluorescence (IF) signal; creating a baseline-corrected agent IF signal by subtracting an auto-fluorescence contribution based on the predicted post-agent administer Flr signal from the calculated IF signal.

Aspect 34. The method of aspect 33, further comprising: searching the IF signal having a minimum variance and constrained to a maximum drift over a predetermined time window.

What is claimed is:

1. A method of monitoring time-varying fluorescence emitted from an exogenous fluorescent agent from within a diffuse reflecting medium with time-varying optical properties, the method comprising:
providing a measurement data set comprising a plurality of measurement entries comprising at least two measurements obtained at each data acquisition time from a patient that is administered the exogenous fluorescent agent, the at least two measurements comprising: at least one diffuse reflectance (DR) signal and at least one fluorescence emission (Flr) signal;
transforming each Flr signal of each measurement data entry of the measurement data set to an agent intrinsic fluorescent (IF) signal representing a detected fluorescence intensity emitted by the exogenous fluorescent agent from within the diffuse reflecting medium, wherein transforming the Flr signal comprises periodically combining the at least two measurements according to a transformation relation comprising at least one variable pathlength factor for the at least one DR signal, wherein the at least one variable pathlength factor is re-determined periodically;
monitoring the agent IF signal for each measurement data entry within the measurement data set, whereby fluorescence emission of the agent is determined with reduced sensitivity to the time-varying optical properties of the medium.

2. The method of claim 1, wherein the at least one DR signal comprises a diffuse reflectance signal at an excitation wavelength of the exogenous fluorescent agent (DRₑₓ) and a diffuse reflectance signal at an emission wavelength of the exogenous fluorescent agent (DRₑₘ).

3. The method of claim 2, wherein transforming the Flr signal to the agent IF signal comprises dividing Flr by a product of (DRₑₘ)^{Kem} and (DRₑₓ)^{(c-Kem)}, where c is a constant and Kₑₘ is determined by a fit that minimizes a variation of the agent IF signal.

4. The method of claim 3, wherein the fit is defined by fitting function:
$$log ( F l r ) - c log ( D {R}_{e x} ) = log ( IF ) + k e m ( log ( D {R}_{e m} ) - log ( D {R}_{e x} ) )$$
and a linear fit is performed wherein an independent variable is log(DRₑₘ)−log(DRₑₓ) and a dependent variable is log(Flr)−c log(DRₑₓ) whereby an offset term from the linear fit is log(IF).

5. The method of claim 2, wherein transforming the Flr signal to the agent IF signal comprises dividing Flr by a product of (DRₑₘ)^{Kem} and (DRₑₓ)^{(r*Kem)}, where r is a constant and Kₑₘ is determined by a fit that minimizes a variation of the agent IF signal.

6. The method of claim 5, wherein the fit is defined by a fitting function, which is:
$$log ( F l r ) = log ( IF ) + k e m ( log ( D {R}_{e m} ) - r log ( D {R}_{e x} ) )$$
and a linear fit is performed wherein an independent variable is log(DRₑₘ)−rlog(DRₑₓ) and a dependent variable is log(Flr) whereby an offset term from the linear fit is log(IF).

7. The method of claim 1, wherein transforming the Flr signal to an IF signal comprises dividing Flr by DR^{K}, where K is determined by a fit that minimizes a variation of the agent IF signal during the period of the fit.

8. The method of claim 7, wherein fit can be defined by a fitting function that is:
$$log ( F l r ) = log ( IF ) + K log ( D R )$$
and a linear fit is performed wherein an independent variable is log(DR) and a dependent variable is log(Flr) whereby an offset term from the linear fit is log(IF).

9. The method of claim 8, wherein the at least one DR signal comprises a diffuse reflectance signal at an emission wavelength of the fluorescent agent (DRₑₘ).

10. A method of monitoring time-varying fluorescence emitted from an exogenous fluorescent agent from within a diffuse reflecting medium with time-varying optical properties, the method comprising:
obtaining a measurement data set comprising a plurality of measurement entries comprising at least two measurements obtained at one data acquisition time from a patient before and after administration of the exogenous fluorescent agent, the at least two measurements comprising: a diffuse reflectance (DR) signal and a fluorescence emission (Flr) signal;
generating at least one coefficient value for combining the DR and Flr signals from at least a portion of the measurement data set obtained prior to administration of the exogenous fluorescent agent to calculate a baseline intrinsic fluorescence (IF) signal;
searching for the baseline IF signal having a minimum variance and constrained to a maximum drift over a predetermined time window;
storing the at least one coefficient value of the baseline IF having the minimum variance and constrained to a maximum drift over the predetermined time window;
creating a baseline-corrected agent IF signal by combining the stored at least one coefficient value with the Flr and DR signals collected after administration of the fluorescence agent; and
monitoring the agent IF signal for each measurement data entry within a post-agent-administration portion of the measurement data set, whereby the fluorescence emission of the agent is determined with reduced sensitivity to the time-varying optical properties of the medium.

11. The method of claim 10, wherein the DR measurement comprises at least two DR measurements at different wavelengths, one corresponding to an excitation wavelength of the exogenous fluorescence agent (DRₑₓ) and another at an emission wavelength of the exogenous fluorescent agent (DRₑₘ).

12. The method of claim 11, wherein the DRₑₘ measurement comprises at least two measurements at an emission wavelength of the exogenous fluorescence agent, a first measurement using a detector which is not optically filtered (DR_{em,unfiltered}) and a second measurement using a detector which is optically filtered (DR_{em,filtered}).

13. The method of claim 10, wherein the at least one coefficient value comprises a plurality of fitting coefficients between DR and Flr.

14. The method of claim 10, wherein the at least one coefficient value comprises a plurality of factors for individually normalizing the Flr and DR signals to 1 during a baseline period.

15. A method of monitoring time-varying fluorescence emitted from an exogenous fluorescent agent from within a diffuse reflecting medium with time-varying optical properties, the method comprising:
providing a measurement data set comprising a plurality of measurement entries comprising at least four measurements obtained at one data acquisition time from a patient before and after administration of the exogenous fluorescent agent, the at least four measurements comprising:
a diffuse reflectance signal at an emission wavelength of the fluorescent agent measured on a first detector that is not optically filtered (DR_{em,unfiltered});
a diffuse reflectance signal at an emission wavelength of the fluorescent agent measured on a second detector that is optically filtered (DR_{em,filtered});
a diffuse reflectance signal at an excitation wavelength of the fluorescent agent measured on the first detector (DRₑₓ); and
a fluorescence emission signal (Flr) measured on the second detector;
identifying a post-agent-administration portion of the measurement data set;
transforming each DRₑₓ signal of each measurement data entry of the measurement data set to a DR_{ex,corr} signal by combining the DRₑₓ signal with the DR_{em,filtered}, DR_{em,unfiltered}, Flr signals and a heterogeneity factor to reduce a Flr contribution to the DRₑₓ signal;
determining the heterogeneity factor by comparing the DR_{ex,corr} signal before and after the agent administration;
transforming each Flr signal of each measurement data entry of the measurement data set to an intrinsic fluorescent (IF) signal representing a detected fluorescence intensity emitted by the exogenous fluorescent agent from within the diffuse reflecting medium, wherein transforming the Flr signal comprises combining the Flr, DR_{em,filtered} and DR_{ex,corr} signals;
monitoring the IF signal for each measurement data entry within the measurement data set, whereby the fluorescence emission of the agent is determined with reduced sensitivity to the time-varying optical properties of the medium.

16. The method of claim 15, wherein transforming of the DRₑₓ signal comprises combining terms according to:
$$D {R}_{e x , corr} = G h c \times D {R}_{e x} \times D {R}_{e m , filtered} / {DR}_{em , unfiltered} - Flr .$$

17. The method of claim 15, wherein the heterogeneity factor is determined by minimizing a deviation of the DRₑₓ signal resulting from the administration of the fluorescent agent.

18. The method of claim 15, wherein a determined value of the heterogeneity factor is compared to at least one threshold that is used to determine validity of the measurement.

19. A method of correcting baseline data in monitoring time-varying fluorescence emitted from an exogenous fluorescent agent, the method comprising:
obtaining a measurement data set comprising a plurality of measurement entries comprising at least two measurements obtained at one data acquisition time from a patient before and after administration of the exogenous fluorescent agent, the at least two measurements comprising: a diffuse reflectance (DR) signal and a fluorescence emission (Flr) signal;
generating at least one coefficient value for predicting a Flr baseline signal from the DR signal, wherein the at least one coefficient value is established using a correlation between the DR signal and Flr signal;
storing the at least one coefficient value;
calculating a predicted post-agent administered Flr signal using the at least one coefficient value;
calculating an intrinsic fluorescence (IF) signal;
creating a baseline-corrected agent IF signal by subtracting an auto-fluorescence contribution based on the predicted post-agent administer Flr signal from the calculated IF signal.

20. The method of claim 19, further comprising: searching the IF signal having a minimum variance and constrained to a maximum drift over a predetermined time window.
